(19) United States
(12) Patent Application Publication
(10) Pub. No.: US 2024/0422660 A1
(43) Pub. Date: Dec. 19, 2024

(54) 5GC SERVICE BASED ARCHITECTURE OPTIMIZATION OF INITIAL SELECTION IN ROAMING

(71) Applicant: Telefonaktiebolaget LM Ericsson (publ), Stockholm (SE)

(72) Inventor: Maria Cruz BARTOLOME RODRIGO, Torremocha de Jarama Madrid (ES)

(21) Appl. No.: 18/699,985

(22) PCT Filed: Oct. 11, 2022
(86) PCT No.: PCT/EP2022/078279

§ 371 Date: Apr. 10, 2024

(30) Foreign Application Priority Data
Oct. 11, 2021 (EP) 21382911.2
Oct. 11, 2021 (EP) 21382913.8

(51) Int. Cl. H04W 48/18; H04L 45/02; H04W 8/08

(52) U.S. Cl. CPC H04W 48/18; H04L 45/02; H04W 8/082

(57) ABSTRACT

Disclosed is a method by a network function service consumer, NFc, including determining whether a request for a service operation to be provided by a network function service producer, NFp, needs to be routed via a security edge protection proxy, SEPP. In this case, information is identified that is used by a consumer public land mobile network, cPLMN, to perform selection or reselection of an NFp to provide the service operation. Based on this information, a producer security edge protection proxy, pSEPP, or a service communication proxy, SCP, can select or reselect an according NFp.

### TECHNICAL FIELD

The present disclosure relates generally to the 5GC service based architecture and communications for selecting a network function service producer to perform a defined service operation.

### BACKGROUND

In 5G Core, an NFc (Network Function service consumer) selects an NFp (Network Function service producer) to execute a service operation. The NFp selected should be able to provide the requested service operation and to ensure that there is certain functional criteria the NFc takes into account for selection, e.g. the NFp shall be able to serve a certain slice, or for a certain DNN (Data Network Name) or subscriber identity. But apart from that, normally there are multiple NFps that will be able to provide equivalent functionality, and then so-called non-functional criteria for selection can be taken into account, which may include NFp values for one or more of proximity, capacity, priority, etc. that are part of the NFp profile.

The NFc may be located in a visited PLMN (vPLMN), sometimes generically referred to as a consumer PLMN (cPLMN), and require a service in a home PLMN (hPLMN) acting as producer PLMN (pPLMN). For example, a roaming user may access its home Unified Data Management (hUDM) via a vAMF (visited Access & Mobility Management Function) in the vPLMN. In that case, the NFc can access NFps in the pPLMN and then perform the selection based on NFp profile information.

A Security Edge Protection Proxy (SEPP) is usually deployed as an edge element between the cPLMN and the pPLMN. For example, In the case of multi-country (multi-tenant) operation, a SEPP may be provided between multiple cPLMNs and/or multiple pPLMNs.

Further, a Service Communication Proxy (SCP) may be included as an Network Element (NE) to provide indirect communication between an NF service consumer and an NF service producer. There are two possible indirect communication modes, referred to as “without delegated discovery” and “with delegated discovery”.

The general architecture of a 5G Core system is described in 3GPP TS 23.501 v17.0.0 System architecture for the 5G System, stage 2, and the specific so-called service based architecture (SBA) in 3GPP TS 29.500 v17.2.0 5G System; Technical Realization of Service Based Architecture; Stage 3.

A common criteria used for selection of an NFp is the Locality, which is an array of strings that have operator specific values. For example, NFp Locality can have values indicating “Region1, DC1”. This parameter can be used by the NFc to select an NFp that could be in the same Locality, or otherwise the closest NFp to the NFc. For example, if NFc is in “Region1,DC2”, it will prefer to select an NFp the same “Region1,DC2”, but if not possible, then will next prefer to select an NFp somewhere within “Region1,*”.

There currently exist certain challenge(s). The NFc may delegate both initial selection and reselection of the NFp to a Service Communication Proxy (SCP) (with indirect communicate mode “with delegated discovery”) or may delegate reselection of the NFp and even initial selection within the a set (with indirect communicate mode “without delegated discovery”) to a SCP. Currently, roaming is not considered specifically with indirect communication. The delegation of initial selection and reselection of the NFp from NFc to SCP is done within the cPLMN. There is currently no provision for delegation to the pPLMN in a roaming scenario.

Moreover, if there are multiple SCPs in the cPLMN signalling path for a request from an NFc to an NFp, it is clearly indicated that one SCP in the path shall perform the delegated tasks. An SCP in the cPLMN must therefore perform initial selection and/or reselection before the request reaches the NFp.

### SUMMARY

The invention provides methods by a consumer network function, a security edge protection proxy and a service communication proxy, corresponding computer programs and devices according to the independent claims. Further embodiments are defined in the dependent claims.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a data flow diagram of operations for selection in cPLMN of NFp without considering Locality in a pPLMN;

FIGS. 2a and 2b illustrate a data flow diagram of operations for selection in pPLMN of NFp with consideration of Locality in a pPLMN with operation of pSEPP, in accordance with some embodiments;

FIG. 3 illustrates a data flow diagram of operations for informing NFc whether the NFp(s) is/are “InterPlmn”, in accordance with one of the two alternative embodiments;

FIGS. 4a and 4b illustrate a data flow diagram of operations for selection in pPLMN of NFp with consideration of Locality in a pPLMN with operation of SCP, in accordance with some embodiments;

FIGS. 5a and 5b illustrate a data flow diagram of operations for selection in pPLMN of NFp with consideration of Locality in a pPLMN with indirect communication in cPLMN, in accordance with some embodiments;

FIG. 6a is a block diagram that illustrates an example scenario in which an NFc located in a vPLMN desires to obtain service from a NFp located in an hPLMN.

FIG. 6b is a flow diagram of operations in which an NFc in a cPLMN seeks to obtain services from an NFp in a different PLMN without delegation.

FIG. 7 is a flow diagram of operations in which an NFc in a cPLMN seeks to obtain services from an NFp in a different PLMN according to some embodiments.

FIG. 8 is a flow diagram illustrating registration by a NFp according to some embodiments.

FIGS. 9, 10 and 11 are a flow diagrams of operations in which an NFc in a cPLMN seeks to obtain services from an NFp in a different PLMN according to further embodiments.

FIG. 12 is a block diagram of a communication system in accordance with some embodiments of inventive concepts;

FIG. 13 is a block diagram of a user equipment in accordance with some embodiments of inventive concepts

FIG. 14 is a block diagram of a network node in accordance with some embodiments of inventive concepts;

FIG. 15 is a block diagram of a host computer communicating with a user equipment in accordance with some embodiments of inventive concepts;

FIG. 16 is a block diagram of a virtualization environment in accordance with some embodiments of inventive concepts; and

FIG. 17 is a block diagram of a host computer communicating via a base station with a user equipment over a partially wireless connection in accordance with some embodiments of inventive concepts.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

When the NFc selects an NFp in a pPLMN, then the Locality value of the NFp may not be properly interpreted by the NFc, because the Locality value is defined in an operator specific manner.

The expectation of usage of the Locality for (re) selection is to allow the (re) selection to be performed to minimize the distances in the signalling paths that need to be established, by selecting an NFp that is geographically “close” to the NFc in the same PLMN. However if the NFp is in another PLMN, the proximity between NFc and NFp (in different PLMNs) may not be a valid criteria to reduce the signalling paths.

Therefore, NFp Locality may not be a valid criteria for selection by an NFc in a cPLMN of an NFp in a pPLMN, which operationally results in the NFp Locality not being taken into account for the selection which is then performed based on other criteria, such as NFp Priority and then available capacity and present load (Capacity&Load).

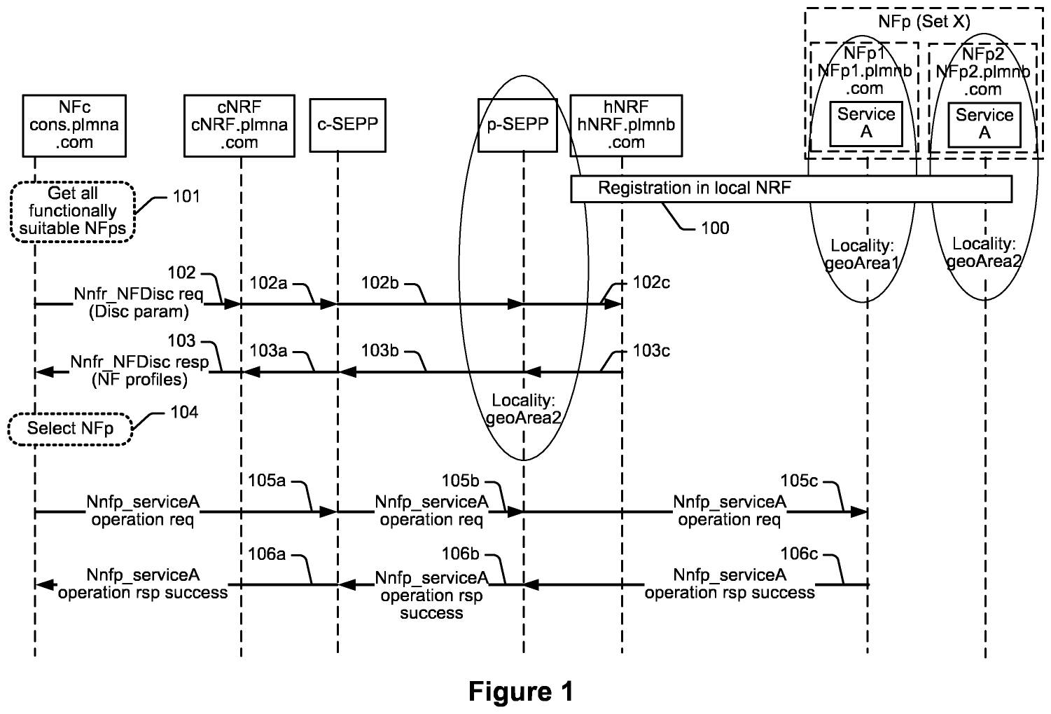

FIG. 1 illustrates a data flow diagram of operations for selection in cPLMN of NFp without considering Locality in a pPLMN.

In Step 100, registration is performed in the local (home) NRF (hNRF) with communications between the hNRF and NFp (including NFp1 and NFp2).

In Step 101, NFc needs to get (e.g., identify) all NFps which are suitable to perform a defined service operation.

In Step 102, to get (e.g., identify) a list of all NFps, NFc performs a Discovery request towards NRF. If the required NFp type is on the pPLMN, then the cNRF needs to get the corresponding NFp profiles from the local NRF in the pPLMN. This interaction is done via the CSEPP (consumer Security Edge Protection Proxy) and pSEPP (producer SEPP). The illustrated Step 102 includes the indicated communications referenced as 102, 102a, 102b, and 102c.

In Step 103, a response from the cNRF provides the obtained NFp profiles to the NFc. The illustrated Step 103 includes the indicated communications referenced as 103, 103a, 103b, and 103c.

In Step 104, NFc selects (or reselects) an NFp using functional and non-functional criteria that depend on the obtained NFp profiles. It is assumed that both NFp1 and NFp2 are functionally equivalent and, therefore, are valid candidates. NFc performs non-functional selection taking into account Locality, Priority, and Capacity (considering Load), which may be performed in this order of precedence (Locality then Priority and then Capacity) for the selection criteria. When Locality has a meaning for a single PLMN it will not be taken into account for selection, and it is assumed that NFp1 is selected.

In Step 105, service operation is sent to the selected NFp1 via the cSEPP and pSEPP. Then, in this example, if pSEPP is located in geoArea2 and pSEPP is located in geoArea1, the selection results in a relatively large distance between pSEPP and NFp1. The illustrated Step 105 includes the indicated communications referenced as 105a, 105b, and 105c.

In Step 106, the service response will occur over a relatively long signalling path distance. The illustrated Step 106 includes the indicated communications referenced as 106a, 106b, and 106c.

Various embodiments of the present disclosure are directed to improving or optimizing the selection process according to selection criteria when roaming, in order to reduce or minimize the resulting distances in the signalling paths in the pPLMN.

Some embodiments are further directed to performing an initial selection (among candidates that are functionally equivalent) in the pPLMN for the incoming requests. A new initial selection takes Locality in the pPLMN into account to reduce or minimize distances of the signalling paths in pPLMN.

The NFc identifies whether the selected NFp is in another PLMN, by analyzing a new attribute which is included in the NFp profile returned to the NFc responsive to the NRF Discovery. In that case, then the NFc needs to identify whether it has to send the request with direct communication in the cPLMN or with indirect communication (specifically “without delegated discovery and only providing target”) or with any other indirect mode. In the two first cases, the NFc needs to newly include headers able to identify the Set (either SetId or NFinstanceId).

The new initial selection (also referred to as “final” selection) can be performed by the pSEPP in case of direct communication in pPLMN. In case of indirect communication in the pPLMN, the new initial selection may be performed by one SCP (Service Communication Proxy) in the path, and for this reason the pSEPP can include a new flag “InterPlmn” to signal the SCP to perform the initial selection in accordance with some embodiment. The term “flag” is used in a non-limited way to refer to any way of signaling the noted indication. A flag may be a binary value or may be any other value or sequence of values which are used to signal the noted indication. Accordingly, the term “flag” is interchangeably used with the term “indication.”

The new initial selection can be performed among functionally equivalent candidates to the one selected originally by the NFc. This means that the selection can be or may need to be performed within the same Set, or in case of indirect communication with delegated discovery in which case there is not any NF instance selected, the new selection can use the parameters provided in the request (i.e., sbi-discovery-* parameters).

Potential advantages that may be provided by one or more of the present embodiments may include, when roaming and the NFc selects an NFp in another PLMN, the Locality in the pPLMN is taken into account in order to reduce or minimize distances of the signalling paths in the request routing in the pPLMN.

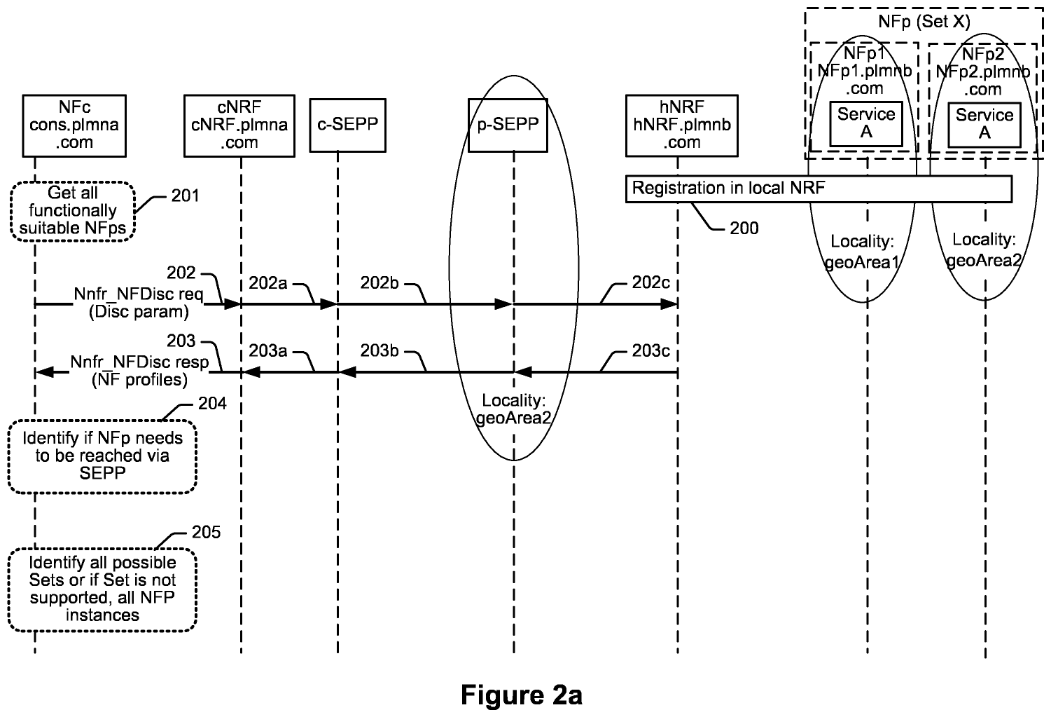

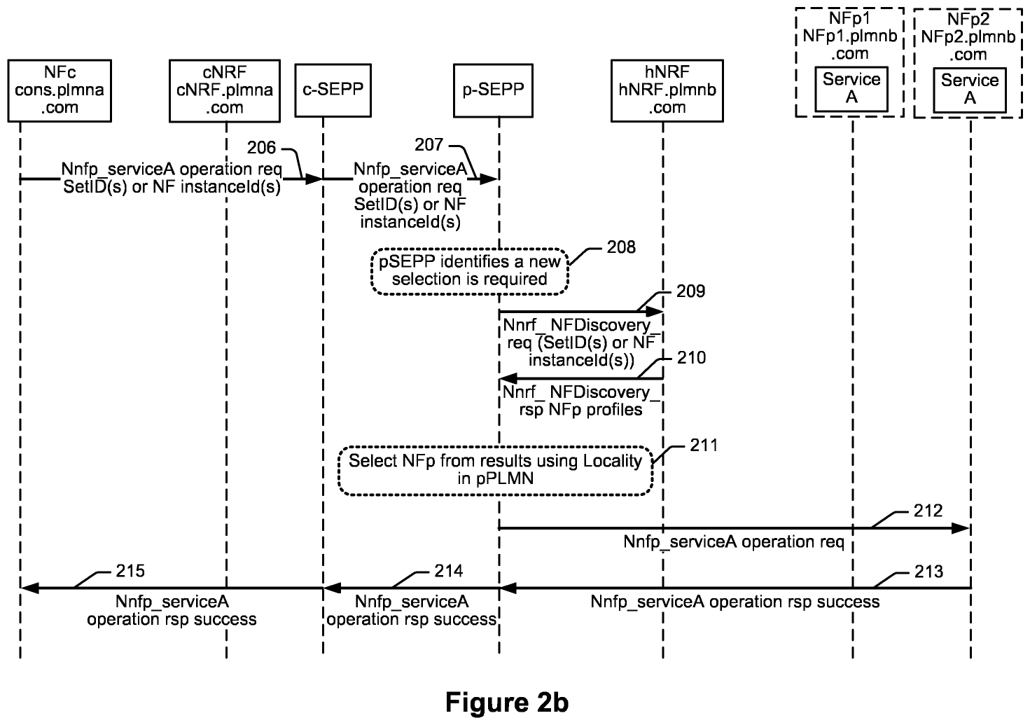

Various embodiments are now described in the context of direct communication in both cPLMN and pPLMN with reference to FIGS. 2a and 2b. The combined FIGS. 2a and 2b illustrate a data flow diagram of operations for selection in pPLMN of NFp with consideration of Locality in the pPLMN with operation of pSEPP, in accordance with some embodiments.

Steps 200 to 203 of FIGS. 2a and 2b may be performed in accordance with the description of the corresponding Steps 100 to 103 in FIG. 1.

In Step 204, in accordance with some present embodiments, the NFc determines whether the request for the defined service operation needs to be routed via a SEPP, such as a CSEPP or pSEPP, such as where the SEPP is in another PLMN than the NFc or is in a group of PLMNs (for multi-country).

Pursuant to 3GPP TS 29.510 v17.1.0, the NFc would not know whether the NFp “fqdn” is in a different PLMN than the NFc, since this knowledge resides in the NRF where the “local PLMNs” are configured. In the case of multicountry (muti-tenant), the network repository function (NRF) may be configured with multiple PLMNs, and only if the PLMN of the NFc does not match any of those multiple PLMNs, then the request is considered to be “InterPlmn”, which may be via PLMN. Table 6.2.6.2.3-1 below illustrates the definition of type NFProfile pursuant to Section 6.2.6.2.3 of 3GPP TS 29.510 v17.1.0.

| Attribute name | Data type | P | Cardinality | Description |
|---|---|---|---|---|
| . . . | | | | |
| fqdn | Fqdn | C | 0 . . . 1 | FQDN of the Network |
| | | | | Function (NOTE 1, |
| | | | | NOTE 3, NOTE 11) |

[. . .]
NOTE 3:
If the requester-plmn in the query parameter is different from the PLMN of the discovered NF, then the fqdn attribute value shall contain the interPlmnFqdn value registered by the NF during NF registration (see clause 6.1.6.2.2). The requester-plmn is different from the PLMN of the discovered NF if it belongs to none of the PLMN ID(s) configured for the PLMN of the NRF.
. . .

In some embodiments, the NRF determines the requester-plmn in the query parameter is different from the PLMN of the discovered NF, then the fqdn attribute value shall contain the interPlmnFqdn value registered by the NF (e.g., NFp) during NF registration. The requester-plmn is different from the PLMN of the discovered NF if it belongs to none of the PLMN ID(s) configured for the PLMN of the NRF.

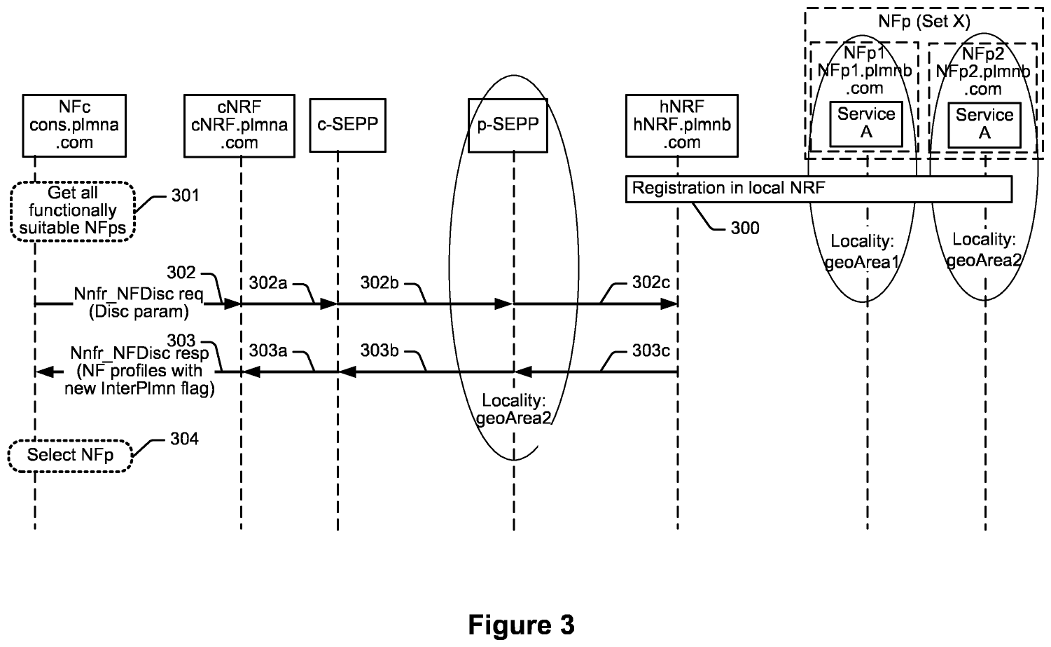

Two alternative embodiments are now explained through which the NFc operates to determine (Step 204) whether the request for the defined service operation to be provided an NFp needs to be routed via a SEPP, which can be a cSEPP (in the consumer or visited network) or pSEPP (in the home or producer network), or can be in a group of PLMNs (for multi-country). FIG. 3 illustrates a data flow diagram of operations for informing NFc whether or which of the NFp(s) is/are “InterPlmn”, in accordance with one of the two alternative embodiments.

Steps 300, 301, 302, and 304 of FIG. 3 may be performed in accordance with the description of the corresponding Steps 200, 201, 202, and 204 in FIGS. 2a and 2b.

In Step 303 of FIG. 3, a flag is included by the NRF in the Discovery response to the NFc to indicate whether the fully qualified domain name (fqdn) value returned, responsive to the Discovery request, includes the “InterPlmn” value. Using this flag, the NFc identifies whether the selected NFp (“initial NFp”) is “InterPlmn”, i.e. belongs to a different PLMN than the one in which the NFc is located. Corresponding operations by the NFc can include receiving 303 a NF discovery response provided by the NRF, where the NF discovery response contains profiles of the NFps and which may contain flags identifying which, if any, of the NFps are InterPlmn. The determining (204) whether the request for the defined service operation needs to be routed via a SEPP comprises determining whether the NF discovery response containing a profile for an identified NFp includes a flag indicating whether a fully qualified domain name associated with the initial NFp includes an InterPlmn value.

In accordance with the second of the two alternative embodiments, the NFc is locally configured with information identifying the “local PLMNIds”, where the locally configured information may be similar to that of the NRF. The NFc uses the locally configured information to determine whether the “fqdn” value is in another PLMN. Corresponding operations by the NFc can include receiving information identifying local PLMN identifiers. The operation to determine 204 whether the request for the defined service operation needs to be routed via a SEPP can be based on determining a fqdn associated with an identified NFp does not correspond to one of the local PLMN identifiers.

Referring again to FIGS. 2a and 2b, in Step 205, when the determining 204 by the NFp determines that the NFp needs to be reached via SEPP (i.e., the request for the defined service operation needs to be routed via a SEPP), then the NFc does not perform initial selection, but instead provides enough information to the hPLMN to allow the initial selection of NFp to be performed by the hPLMN, e.g., by the SEPP or SCP. This information may include the NF (service) Set Id(s) to the ones the returned NFp instances belong (for that the NFc needs to check the NF (service) Set Id in the NFp instance profile), or in case the Set is not supported, then the NFc provides all the returned NF instances (e.g., in the Discovery response). In this way, the NFc does not perform an initial selection that may not consider relevant attributes, such as NFp Locality.

Corresponding operations by the NFc can include, when the determining 204 is that the request for the defined service operation needs to be routed via a SEPP, further identifying 205 information that is used by a consumer cPLMN to perform selection or reselection of an NFp, and sending 206 the request for the defined service operation with the identified information for routing via the SEPP.

In Step 206 a service operation request including the identified information is sent to the selected NFp1 via the SEPP, e.g., cSEPP and pSEPP.

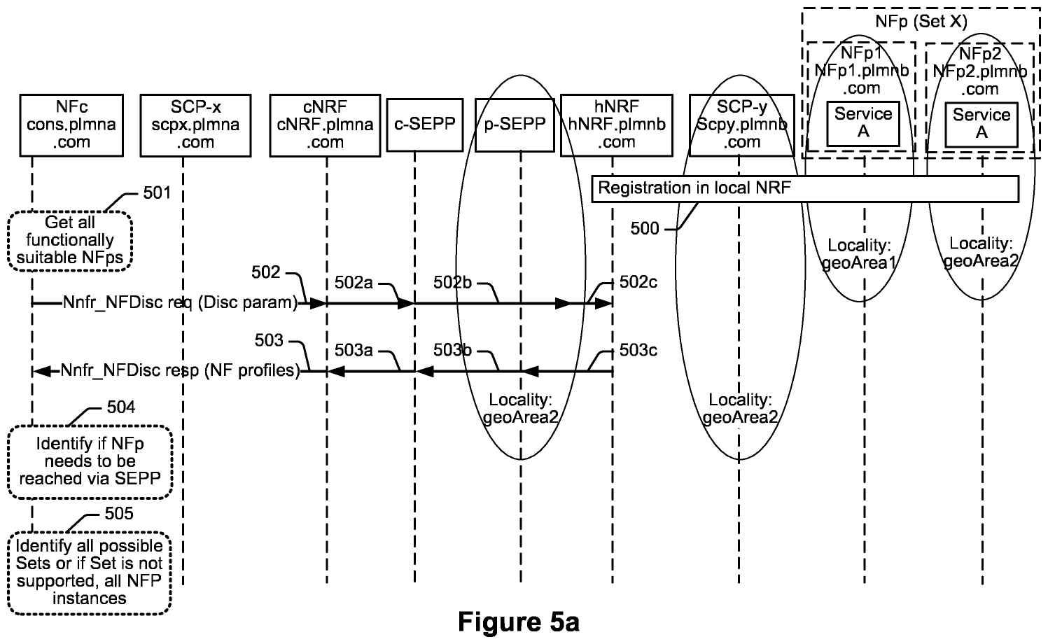

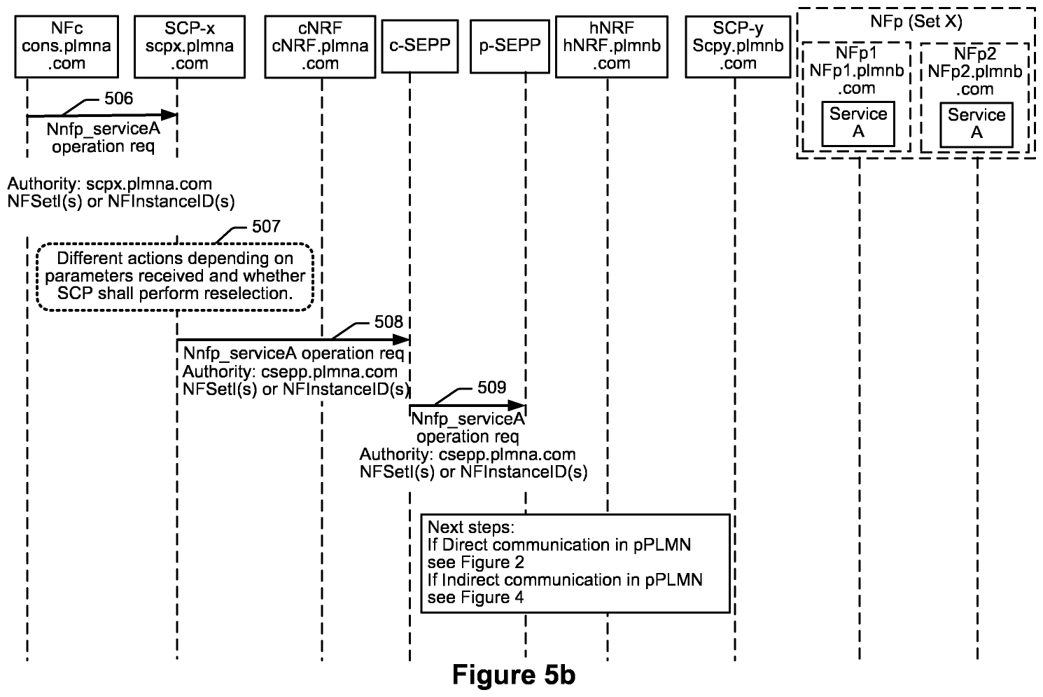

In the illustrated example, the service operation request is sent directly to the cSEPP and pSEPP, which is referred to as direct communication in the cPLMN. In contrast, for indirect communication in the cPLMN example operations are explained below with reference to FIG. 5. In accordance with some embodiments, if in Step 204 the NFc has determined that the NFp is “InterPlmn” then the NFc includes in the request information which triggers and enables the pSEPP to identify all the NFp (service) SetId(s) or all the the NFp instances as the originally discovered NFp by the NFc (based on functional discovery). This information may be communicated in HTTP headers.

In some further embodiments, when the determining 204 by the NFc determines that the request for the defined service operation does not need to be routed via a SEPP, the NFc then selects or reselects (e.g., 104 in FIG. 1 or 304 in FIG. 3) an NFp from among the list of NFps using criteria applied to NFp profiles of the NFps, and sends (e.g., 106 in FIG. 1) the request for the defined service operation to be provided by the NFp.

It is noted that in existing 3GPP TS specifications, HTTP headers to convey NF instance Id and NF (service) Set Id are provided, i.e.: sbi-discovery-nf-set, sbi-discovery-nf-instance. However, the usage of these headers (and all the sbi-discovery-* parameters) is limited to indirect communication, in order to convey some information from the NFc to SCP (or from one SCP to another SCP).

It is further noted that in existing 3GPP TS specifications, there are two different operational ways to establish a routing via SEPP, one operational way requires the NFc (or SCP for indirect communication in the cPLMN) include sbi-target-apiroot with a target destination in the pPLMN. This is not illustrated in FIG. 2 for simplicity.

In some embodiments, the sending 206 of the request for the defined service operation with the identified information to the SEPP includes, responding to when the determining 204 determines that the request for the defined service operation needs to be routed via a SEPP and not via a SCP, by including in the request set information for the NFc (or alternatively for an initial NFp selected by the NFc) to be used by a pSEPP to identify any NFp instances in a same set as a set indicated by the set information.

In Step 207, the service request reaches pSEPP.

In Step 208, in accordance with some present embodiments, pSEPP receives the request from a cSEPP and identifies that an initial NFp selection is required. The pSEPP is configured to respond to presence of the information included with the service operation request, by identifying that an initial NFp selection is required and responsively performing the initial NFp selection.

In Step 209, in accordance with some present embodiments, pSEPP operates to perform the initial NFp selection using the information included with the service operation request. To perform the NFp selection, if SetId(s) is provided in the information received with the service operation request, the pSEPP performs (sends) a Discovery request towards NRF indicating the SetId(s), in order to get all the NF instances in the Set(s). In contrast, if NFinstanceId(s) is provided in the information received with the service operation request, then for pSEPP to perform the selection of initial NFp, the pSEPP operates to first get the NFinstanceId(s) profile(s).

In one corresponding embodiment, when the request received 207 from cSEPP contains a SetId, the request is forwarded 209 with the SetId. The response received 210 from the NRF provides profiles for NFp instances that are identified by the NRF based on the SetId.

In another corresponding embodiment, when the request received 207 from cSEPP contains an NFinstanceId, the cSEPP operates to get a NFinstanceId profile for the NFinstanceId. The cSEPP then forwards 209 the request with a SetId determined based on the NFinstanceId profile. The response received 210 from the NRF provides profiles for NFp instances that are identified by the NRF based on the SetId.

In Step 210, in accordance with some present embodiments, pSEPP gets NF profiles in a response from NRF, e.g., in a NF discovery response.

In Step 211, in accordance with some present embodiments, pSEPP performs a NFp selection among the NF profiles provided in the NF discovery response from the NRF. The pSEPP performs the initial NFp selection taking Locality into account, such as to find the NFp “closest” to locality of the pSEPP. Thus, in some embodiments, the pSEPP selects the initial NFp based on the NF profile for that NFp satisfying a defined criteria for being local to the pSEPP and/or to the NFc.

In Steps 212 and 213, in accordance with some present embodiments, the service operation request reaches the NFp that is selected in Step 211 based on Locality.

Steps 214 and 215 can respectively correspond to Steps 106b and 106a in FIG. 1.

In accordance with some embodiments, corresponding operations that can be performed by the pSEPP can include receiving 207 from the cSEPP a request by the NFc for a defined service operation, wherein the request includes information to be used to perform selection or reselection of NFp to provide the defined service operation. The pSEPP identifies 208 that a new selection or reselection of NFp to provide the defined service operation is needed based on the information in the request. the cSEPP then selects or reselects 211 an NFp using the information in the request.

In a further embodiment, the cSEPP forwards 209 the request to the NRF using the information, and receives 210 a response from the NRF providing profiles for NFp instances. The cSEPP selects or reselects 211 among the profiles for the NFp instances to identify the NFp that satisfies a criteria for being local to the pSEPP, and sends 212 a service operation request for the NFp.

In one further embodiment, the request received 207 from cSEPP contains a SetId, and the request is then forwarded 209 with the SetID. The the response received 210 from the NRF provides profiles for NFp instances that are identified by the NRF based on the SetId.

In another further embodiment, the request received 207 from cSEPP contains an NFinstanceId. The cSEPP gets a NFinstanceId profile for the NFinstanceId. The cSEPP then forwards 209 the request is with a SetId determined based on the NFinstanceId profile. The response received 210 from the NRF provides profiles for NFp instances that are identified by the NRF based on the SetId.

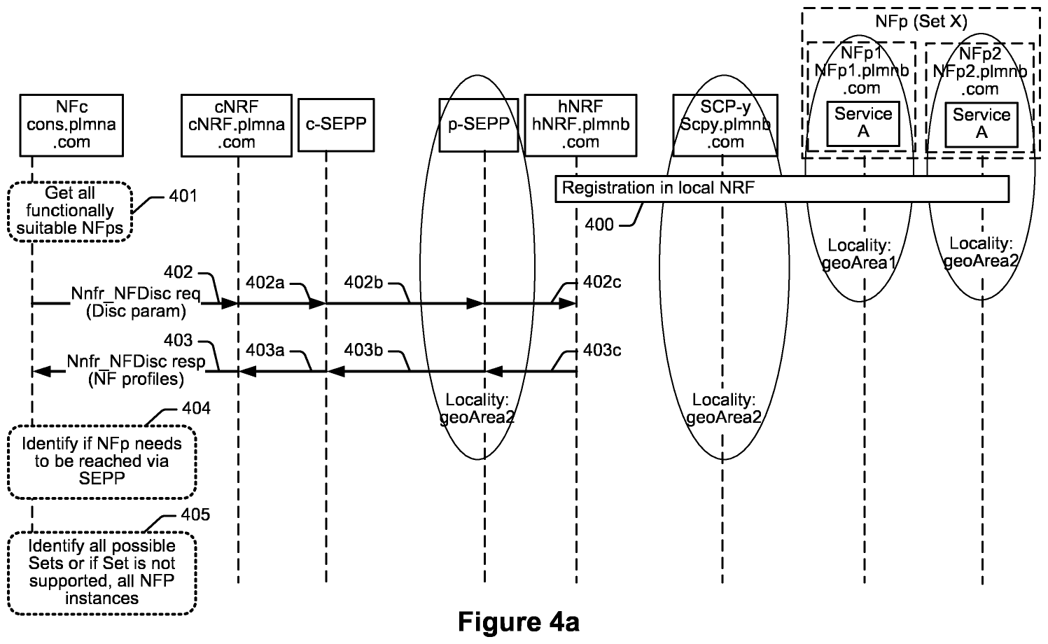

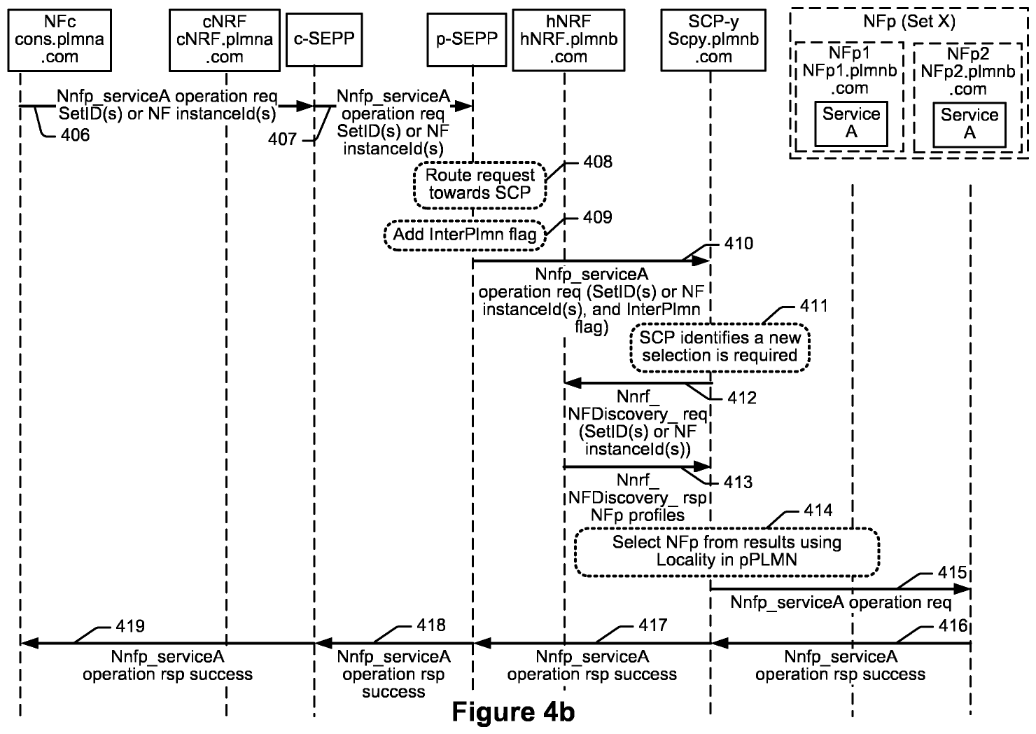

Various other embodiments are now described in the context of direct communication in cPLMN and indirect communication in pPLMN with reference to FIGS. 4a and 4b. The combined FIGS. 4a and 4b illustrate a data flow diagram of operations for selection in pPLMN of NFp with consideration of Locality in a pPLMN with operation of SCP, in accordance with some embodiments.

Referring to FIGS. 4a and 4b, Steps 400 to 407 may be performed in accordance with the description of the corresponding Steps 200 to 207 in FIGS. 2a and 2b.

In Step 408, pSEPP routes (determines routing for) the request towards the next hop in pPLMN.

Step 409 is optional. When performed in accordance with some present embodiments, in Step 409 if the pSEPP identifies that the next hop is an SCP, that is, there will be indirect communication to reach the destination, then the pSEPP adds the “InterPlmn” flag. The “InterPlmn” flag may be added as a new HTTP header in the request. The inclusion of the “InterPlmn” flag is not strictly required because by the presence of the SetId(s) or NFInstanceId(s) the SCP (step 411) is configured to respond by performing a new selection of initial NFp.

It is noted that even in case of indirect communication in the pPLMN, the pSEPP may be configured to perform the new selection, such as using the steps and associated operations described for FIGS. 2a and 2b. In the case the pSEPP performs the new selection, the pSEPP would then not include the InterPlmn flag in the request.

In Step 410, in accordance with some present embodiments, the request with the optionally added “InterPlmn” flag is forwarded to the next SCP in the signalling path. As noted, the pSEPP based on its configuration, includes the new information from the request earlier received by the pSEPP and optionally adds (Step 409) the “InterPlmn” flag.

In Step 411, in accordance with some present embodiments, the SCP identifies based on the new information received or optionally based on the flag InterPlmn (when was added by pSEPP), that a new selection is required. The SCP may be configured to support this new initial selection of NFp depending on the operator's defined preference.

Steps 412, 413, and 414 may be performed by the SCP in accordance with the description of the corresponding Steps 209, 210 and 211 in FIGS. 2a and 2b performed by the pSEPP.

In Step 415, in accordance with some present embodiments, the request reaches the NFp that is selected considering (based on) Locality.

In Steps 416 to 419, a response to the request is communicated from the selected NFp to the NFc via the SCP, pSEPP, and cSEPP.

Corresponding operations that can be performed by the pSEPP of FIGS. 4a and 4b are now explained in accordance with some embodiments.

The pSEPP can operate to receive 407 from the cSEPP a request by a NFc for a defined service operation. The pSEPP determines 408 a routing path for the request toward a next hop in the pPLMN. In response to the next hop in the routing path being a service communication proxy, SCP, the pSEPP adds 409 to the request an InterPlmn flag. The pSEPP then forwards 410 the request with the InterPlmn flag to the SCP in the routing path.

In a further embodiment, the InterPlmn flag is added to an HTTP header in the request.

Corresponding operations that can be performed by the SCP of FIGS. 4a and 4b are now explained in accordance with some embodiments.

The SCP can operate to receive 410 from the pSEPP the request by the NFc for the defined service operation, wherein the request includes information to be used to perform selection or reselection of NFp to provide the defined service operation. The SCP identifies 411 based on the information in the request that a new selection or reselection of NFp to provide the defined service operation is needed. The SCP selects or reselects 414 an NFp using the information from the request.

In a further embodiment, the SCP sends 412 a request to the NRF using the information from the request, and receives 413 a response from the NRF providing profiles for NFp instances. The SCP selects or reselects 414 among the profiles for the NFp instances to identify the NFp that satisfies a criteria for being local to the pSEPP. The SCP generates 415 a service operation request for the NFp.

In a further embodiment, the response received 413 from the NRF provides profiles for the NFp instances that are in a same set as a set indicated by the information.

In a further embodiment, the sending 412 of the request to the NRF using information from the request includes, based on the request received 410 from the pSEPP including a set identifier, sending a discovery request that includes the set identifier.

In another further embodiment, the the sending 412 of the request to the NRF using information from the request includes, based on the request received 410 from the pSEPP including a NFinstanceId, getting a NFinstanceId profile for the NFinstanceId. The SCP sends 412 a discovery request that includes a SetId determined based on the NFinstanceId profile.

Various other embodiments are now described in the context of indirect communication (without delegated discovery) in cPLMN, with either direct or indirect information in pPLMN, with reference to FIGS. 5a and 5b. The combined FIGS. 5a and 5b illustrate a data flow diagram of operations for selection in pPLMN of NFp with consideration of Locality in a pPLMN with indirect communication in cPLMN, in accordance with some embodiments.

Referring to FIGS. 5a and 5b, Steps 500 to 505 may be performed in accordance with the description of the corresponding Steps 200 to 205 in FIG. 2a.

It is noted that there are multiple variants of indirect communication, specifically “without delegated discovery” may include only the selected NFp (by the NFc) in the request such as by inclusion of an HTTP header which may be named sbi-target-apiroot and/or one single NF (service) set.

In Step 506, a request for the defined service operation is sent to the SCP-x. In accordance with some present embodiments, inclusion of SetId(s) or NFinstanceId(s) (similar to FIG. 1) for the case of indirect communication is mode “without delegated discovery”. In some embodiments, only one NF (service) SetId or NFinstanceId is included in accordance with some present protocols.

In Step 507, SCP will perform different actions depending on the received parameter and other parameters.

In Steps 508 and 509, a request is forwarded to pSEPP via c-SEPP. In accordance with some embodiments, inclusion of SetId(s) or NFinstanceId(s) are included such as with operations similar to Step 506.

For the illustrated next steps reference is made to FIGS. 2a and 2b for direct communication in pPLMN or to FIGS. 4a and 4b for indirect communication in pPLMN.

As previously indicated, the delegation of initial selection and reselection of the NFp from NFc to SCP is done within the cPLMN. There is currently no provision for delegation to the pPLMN in a roaming scenario.

In intra-PLMN communication, 3GPP has defined indirect communication via the SCP, allowing for different levels of selection delegation to the SCP within a PLMN.

For inter-PLMN communication in roaming, it is not precluded to convey 3gpp-Sbi-discovery-* parameters between SEPPs to allow selection delegation to the hPLMN. However, although 3gpp-Sbi-discovery-* parameters may be conveyed between SEPPs, the selection delegation options for inter-PLMN communication are not yet well defined or documented.

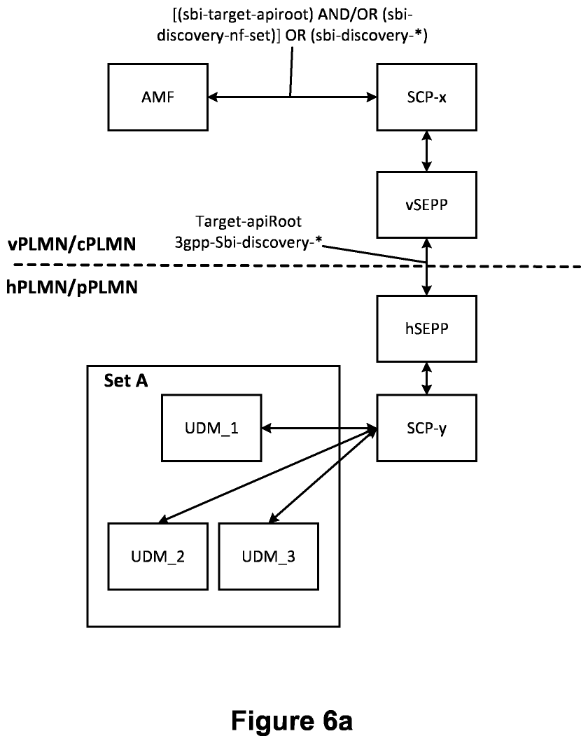

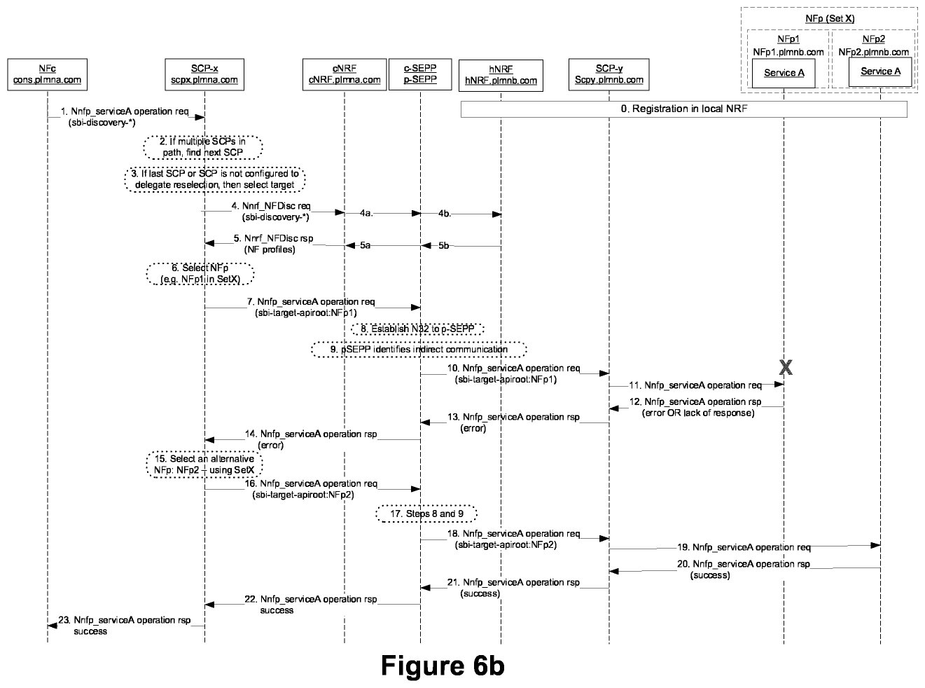

FIG. 6a illustrates an example scenario in which an NFc (e.g., an AMF) located in a vPLMN desires to obtain service from a NFp (e.g., a UDM) located in an hPLMN. Accordingly, in this example, the vPLMN is a cPLMN, while the hPLMN is a pPLMN.

As shown in FIG. 6a, 3gpp-sbi-discovery-* headers may traverse from the cPLMN to the pPLMN when the service operation request is sent to the pPLMN.

However, the operator of a cPLMN and the operator of a pPLMN may have chosen different indirect communication modes for their networks (i.e., with or without delegated discovery). For example, in the pPLMN the operator may have deployed Indirect Communication “with delegated discovery” or Indirect Communication “without delegated discovery” but including NF Set. In both cases, this means that the operator is expecting the SCP-y in pPLMN to perform reselection and even potentially initial selection. However, if none of the sbi-discovery-* header traverses from cPLMN to pPLMN this would not be possible.

Depending on the circumstances, such a situation may result in significant excess signalling overhead. For example, FIG. 6b illustrates a system in which an NFc in a cPLMN (plmna) seeks to obtain services from an NFp in a different pPLMN (plmnb).

Referring to FIG. 6b, at Step 1, a service request is initiated by an NFc using indirect communication with delegated discovery. The sbi-discovery-* parameters are included, and the request is sent to the first SCP (SCP-x) in the signalling path.

At Step 2, the SCP-x checks to see if there is another SCP to send the request to, and checks its configuration to determine if it has to delegate initial selection and/or reselection to the subsequent SCP in the path. (Note that this may be performed after Step 6).

At Step 3, If SCP-x is the last SCP in the signalling path in the cPLMN (or if there is another SCP in the signalling path but SCP-x is configured to not delegate initial selection and/or reselection to the subsequent SCP in the signalling path), SCP-x will need to select a destination NFp (i.e., a target).

At Step 4, SCP-x performs NRF discovery towards the cNRF using the sbi-discovery-* parameters. The discovery will involve an interaction by the cNRF to the pNRF in the pPLMN. Interaction from cNRF to pNRF is required, with long signalling paths.

At Step 5, an NRF discovery response including suitable NFp profiles is returned to SCP-x.

At Step 6, SCP-x selects an NFp (NFp1) from the NFp profiles in an identified set (SetX).

At Step 7, SCP-x sends a service operation request toward the NFp via SEPP. Because SCP-x performed initial selection, the service operation request includes the sbi-target-apiroot parameter, where “apiroot” refers to an application programming interface, API, root of the target.

At Steps 8 and 9, the cSEPP and pSEPP provide the request to the pPLMN. If there is indirect communication in the pPLMN, the request will reach the first SCP in the signalling path (SCP-y).

At Step 10, the request reaches SCP-y in the pPLMN. The request includes the sbi-target-apiroot parameter. This means that the SCP-y is unable to perform initial selection as well as reselection. The ability to perform initial selection and reselection of NFp is one of the main purposes of SCP-y in the pPLMN network. Disabling that functionality in SCP-y reduces the efficiency of the pPLMN network.

At Step 11, SCP-y sends a service operation request to the selected NFp (NFp1) in the identified NFp set (SetX).

At Step 12, in the present example, the selected NFp (NFp1) returns an error message (or fails to respond). However, SCP-y is unable to perform reselection, since it has not received the information needed to be able to identify alternative NFps in the same selected set. That is, because SCP-y has only received the sbi-target-apiroot parameter, SCP-y cannot perform reselection.

Accordingly, at Step 13 and 14, SCP-y sends an error response to SCP-x in the cPLMN.

At Step 15, SCP-x selects an alternative NFp in the same selected set. This means that in case of failure, the response needs to reach cPLMN again, where reselection is performed. This requirement may increase signalling latency and bandwidth utilization in the network.

At Steps 16 to 19, a request to a new selected NFp (NFp2) reaches its destination via SEPP.

At Steps 20 to 23, a successful response is returned to the NFc.

Some embodiments described herein provide mechanisms to allow 3gpp-sbi-discovery parameters to traverse from a cPLMN to a pPLMN.

Some embodiments described herein provide a mechanism by which an SCP in a cPLMN may determine that an NFp is located in a different PLMN, and if so not to perform initial selection. Instead, the SCP delegates initial selection and reselection to the pPLMN. Further, in the case of a multiple SCP path in the cPLMN some embodiments provide for inclusion of an indication from an SCP to the next SCP in the signalling path in the cPLMN, so that the SCP can inform the next SCP in the signalling path that the request should be routed inter-PLMN.

Embodiments described herein may provide certain advantages. For example, the delegation of (re) selection to traverse from cPLMN to pPLMN may allow a SCP in the pPLMN to fully utilize its capabilities (e.g., by performing reselection in case of failure and/or initial selection).

Moreover, some embodiments may reduce processing by SCPs in a multi-SCP path in a cPLMN, and/or reduce signalling towards the NRF.

In particular, in some embodiments described herein, upon receiving a service operation request identifying an NFp, an SCP may determine whether the NFp is in a different PLMN. If so, rather than performing initial discovery as in previous approaches, the SCP may delegate initial discovery to an SCP in the pPLMN.

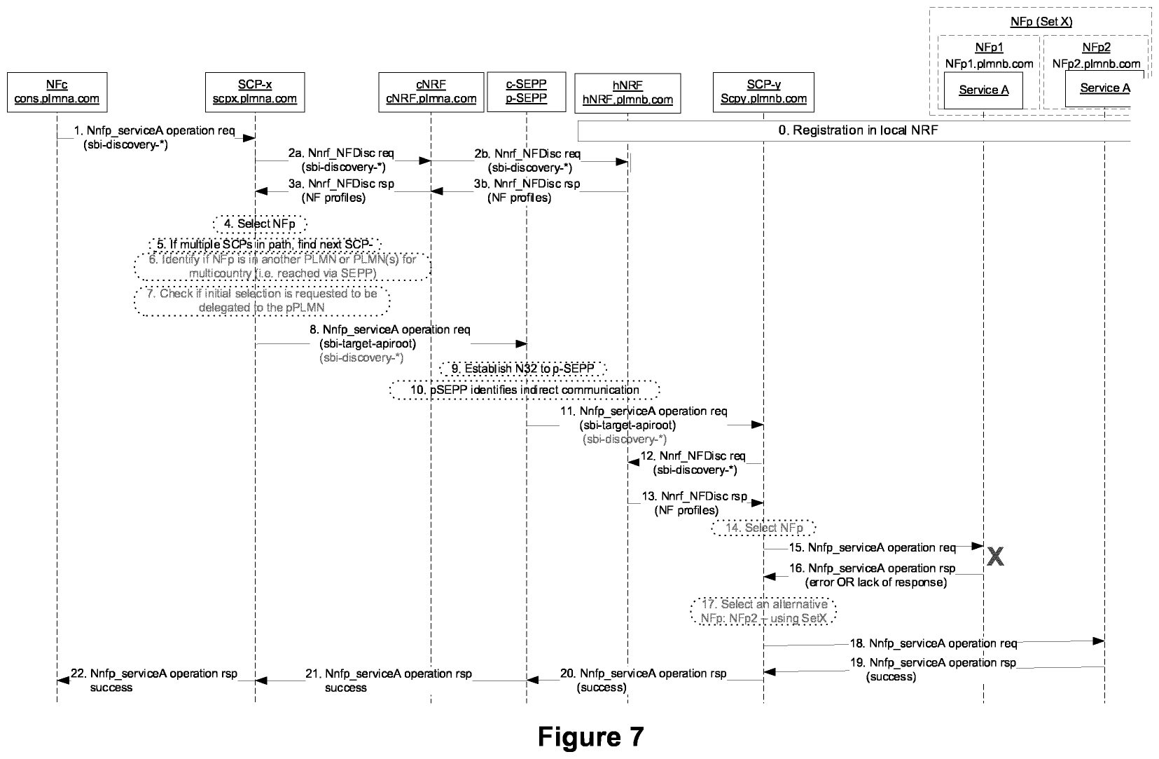

Operations according to some embodiments are illustrated in FIG. 7. Referring to FIG. 7, at Step 1, a service operation request is initiated by an NFc using indirect communication with delegated discovery. The SBI discovery parameters (sbi-discovery-*) are included in the request, and the request is sent to the first SCP (SCP-x) in the signalling path.

At Step 2, SCP-x performs NRF discovery towards the cNRF using the sbi-discovery-* parameters. The discovery will involve an interaction by the cNRF to the pNRF in the pPLMN. Interaction from cNRF to pNRF is required, with long signalling paths.

At Step 3, an NRF discovery response including suitable NFp profiles is returned to SCP-x.

At Step 4, SCP-x selects an NFp (NFp1) from the NFp profiles in an identified set (SetX).

At Step 5, the SCP-x checks to see if there is another SCP to send the request to, and checks its configuration to determine if it has to delegate initial selection and/or reselection to the subsequent SCP in the path.

At Step 6, the SCP (SCP-x) needs to identify whether the target is in another PLMN or group of PLMN(s) server by same operator (for so called multi-country). That is, the SCP has to determine whether the request will need to traverse via c/pSEPP to reach the NFp.

If the selected target is in another PLMN, that is, it is “InterPlmn”, then the routing of the request is performed via SEPP.

To determine whether the target is in another PLMN, the SCP may obtain information from the SCP domain route, which may be obtained from the NRF using a SCPDomainRoutingInfoGet operation. Optionally, the SCP may subscribe to the NRF via a SCPDomainRoutingInfoSubscribe operation and be notified of that information via a SCPDomainRoutingInfoNotify operation.

In some embodiments, a flag may be included in the NRF discovery response that indicates whether or not the fully qualified domain name (“fqdn”) of the NFp includes the “InterPlmn” value. As another alternative, the SCP may be configured with identities of local PLMNs, i.e., “local PLMNIds,” so that the SCP can check to see whether the value received from NRF in “fqdn” is in a different PLMN.

At Step 7, once the SCP has identified that the NFp will be reachable via c/pSEPP, the SCP checks to see whether it is requested that the selection is delegated to the pPLMN. This could be done by checking a new attribute in the NFp profile of the target NFp, that indicates whether the selection should be delegated to the pPLMN in case of roaming and indirect communication in the cPLMN.

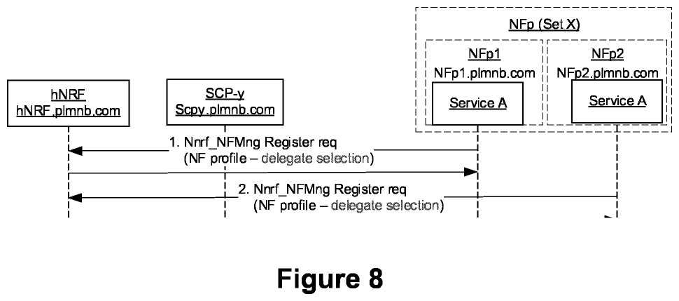

In order to do that, it is required that the NFp in the pPLMN registers the new attribute in its profile. The registration is referenced in step 0 in FIG. 7, and shown in more detail in FIG. 8, to which brief reference is made. As shown in FIG. 8, an NFp (NFp1) sends an NRF registration request (Nnrf_NFMng Register req) to the hNRF. The NRF registration request includes the attribute “delegate selection” in its profile whether the selection should be delegated to the pPLMN in case of roaming and indirect communication in the cPLMN.

Returning to FIG. 7, at Step 8, if the NFp is “InterPlmn,” the SCP-x allows delegation to the pPLMN. For that, the SCP-x includes sbi-discovery-* parameters in the request. SCP-x needs to find a target because to perform routing via c/pSEPP based on sbi-target-apiroot, this header is mandatory to be provided.

At Steps 9 and 10, the cSEPP and pSEPP provide the request to the pPLMN. If there is indirect communication in the pPLMN, the request will reach the first SCP in the signalling path (SCP-y).

At Step 11, sbi-discovery-* parameters are conveyed transparently by the cSEPP/pSEPP to the first SCP in the pPLMN. Current specifications do not preclude that sbi-discovery-* headers traverse transparently, but nothing is indicated about when and how this is possible and the implications with respect to the Indirect Communication in the pPLMN. Optionally sbi-target-apiroot may be provided, since it was received from cPLMN.

At Steps 12, 13, and 14, based on conveyed sbi-discovery-* parameters, the SCP-y is able to perform initial selection of an NFp (NFp1), directly in the pPLMN.

At Step 15, a request to the selected NFp (NFp1) reaches its destination. In this example, the selected NFp responds with an error at Step 16.

At Step 17, SCP-y selects an alternative NFp (NFp2) in the same selected set. In contrast to prior approaches, the SCP does not have to send an error message back to SCP-x for SCP-x to perform reselection.

At Step 18, SCP-y sends a service operation request to the re-selected NFp in SetX (NFp2), which responds to SCP-y in Step 19 with a message indicating success. The success response is then sent back to the NFc via SEPP in Steps 20 to 22.

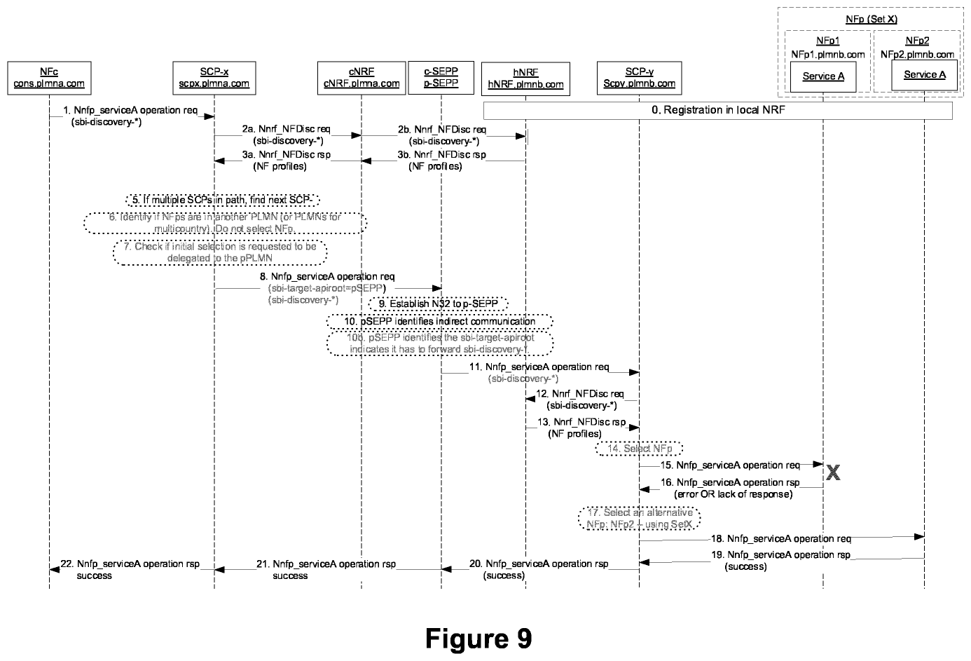

A variant to approach shown in FIG. 7 is illustrated in FIG. 9 in which the initial selection in the visited PLMN is avoided. Operations shown in FIG. 9 are similar to those shown in FIG. 7, except that in the operations of FIG. 9, NFP selection in Step 4 of FIG. 7 is skipped. Step 6 of FIG. 9 is similar to FIG. 7, with the difference that, in this case, the SCP may check all the potential NFps to determine whether they are in a different PLMN.

At Step 8, the SCP uses a dummy target when sending the service operation request to the pSEPP, setting the header sbi-target-apiroot to the apiroot of the pSEPP, or alternatively to an apiroot the pSEPP identifies as an indication that the request includes a delegation of selection. This could, for example, be a virtual identification of the home network. As in FIG. 3, the service operation request in Step 8 includes sbi-discovery-* parameters.

At Step 10b, the pSEPP determines that the request includes a delegation of selection, and that it has to forward the sbi-discovery-* parameters to SCP-y.

The remaining operations of FIG. 9 are similar to those described above with respect to FIG. 7.

Another variant to operations illustrated in FIG. 7 is shown in FIG. 10. In the embodiments illustrated in FIG. 6, the delegation of the selection to the pPLMN is done by the cPLMN (by default) and it is up to the pSEPP to check whether the delegation should indeed be executed.

The steps in the operations of FIG. 10 are the same as those described above with respect to FIG. 9, with the following exceptions.

At Step 7, rather than checking to see if the initial selection is requested to be delegated to the pPLMN, SCP-x takes as granted that selection logic should always be delegated to the pPLMN.

At Step 10b, since the cPLMN will always perform delegation, the pSEPP is configured to check whether delegation should be executed. For example, depending on the configuration, the decision whether or not to execute delegation could be with different granularities. For example, in one configuration, delegation may be preferable for the entire pPLMN. In another configuration, delegation may be preferable only for certain NF types, etc.

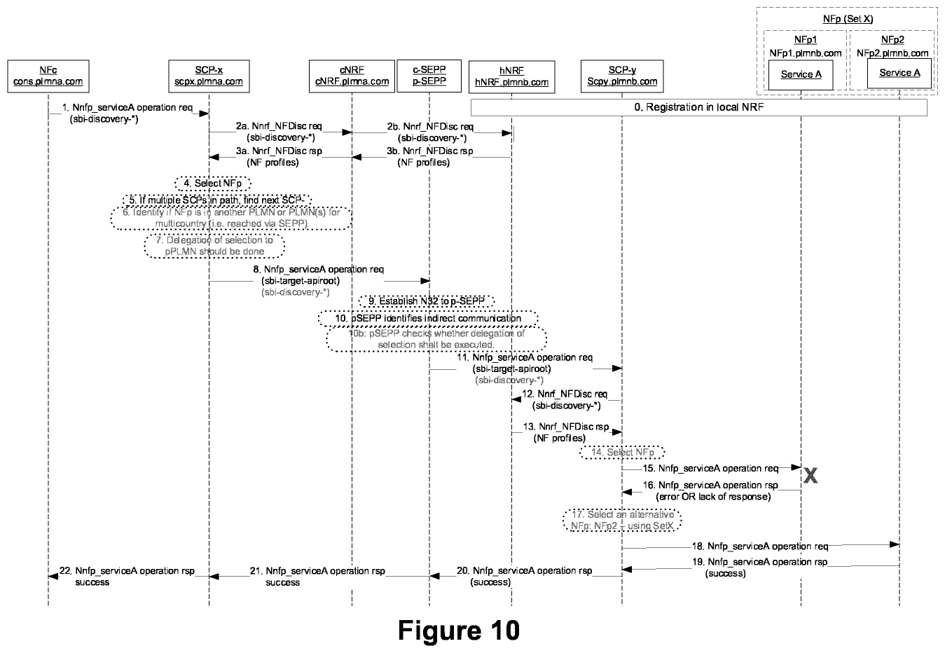

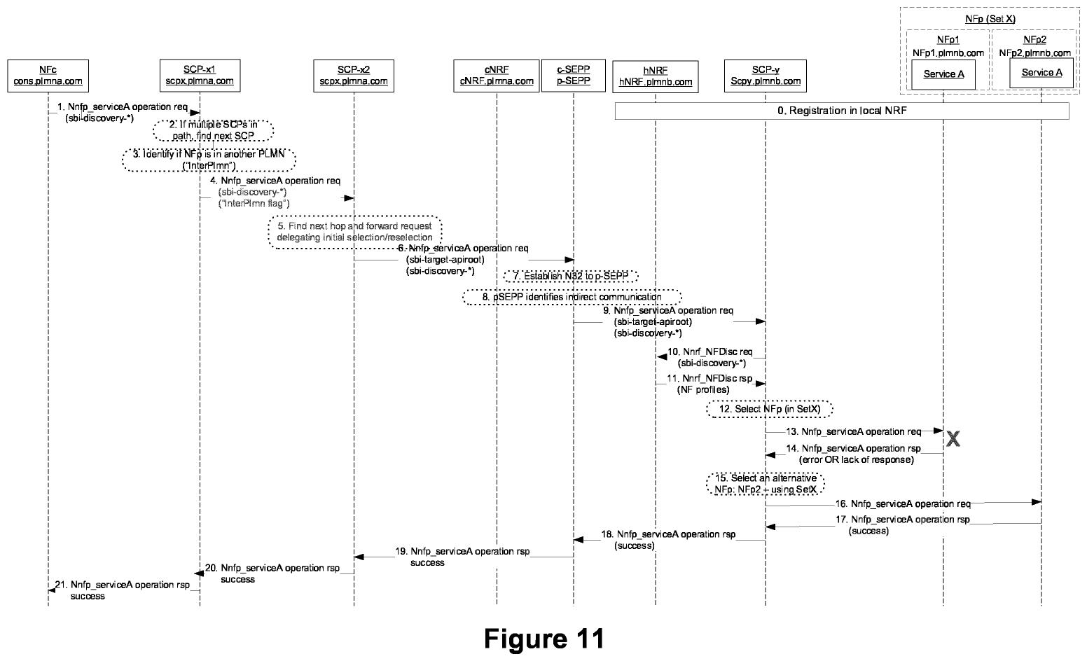

Operations according to further embodiments in which there are multiple SCPs in the signalling path are illustrated in FIG. 11.

Referring to FIG. 11, Steps 1 to 3 are similar to Steps 1 to 3 shown in FIG. 7, except that the service operation request is sent to an SCP SCP-x1. After SCP-x1 determines that the selected NFp is in another PLMN, SCP-x1 determines that there is another SCP (SCP-x2) in the signalling path that the request should be forwarded to.

At Step 4, SCP-x1 forwards the service operation request to SCP-x2. The forwarded request includes a flag, e.g. an “InterPlmn” flag, that indicates to the receiver (SCP-x2) that the request needs to be sent to another PLMN (via SEPP).

At Step 5, upon receipt of the forwarded request with the InterPlmn flag indicating that it has to delegate initial selection and/or reselection to pPLMN, SCP-x2 includes SBI parameters (via an sbi-discovery-* header) in the request and sends the request to the pPLMN via SEPP (cSEPP/pSEPP). Then, the SCP does not need to perform any extra processing (e.g., avoiding NRF interaction), but just conveys the information to the cSEPP. Note that this would be the case when this SCP is the last in the path before the cSEPP. If there are more SCPs in the path, the SCP will need to find the next SCP in path, and unless it is configured, it may require NRF interrogation.

Steps 6 to 21 are similar to those described above with respect to Steps 8 to 22 in

FIG. 7.

Specific embodiments relating to FIGS. 6a to 11are listed in the following:

### Group A Embodiments

1. A method performed by a first network function, NF, in a core network, CN, of a first public land mobile network, PLMN, the method comprising:
receiving (902) a service operation request from a NF service consumer, NFc, in the first PLMN;
performing (904) an NF discovery procedure to identify a NF service producer, NFp, to which the service operation request can be transmitted;
determining (906) that the NFp is located in a second PLMN; and
in response to determining that the NFp is located in the second PLMN, delegating (908) selection of the NFp to a second NF in the second PLMN.
2. The method of Embodiment 1, wherein the first network function comprises a service communication proxy, SCP, in the CN.
3. The method of Embodiment 2, wherein determining that the NFp is located in the second PLMN comprises obtaining SCP domain route information for the NFp.
4. The method of Embodiment 3, wherein obtaining the SCP domain route information for the NFp comprises obtaining the SCP domain route information for the NFp from a network repository function, NRF, in the second PLMN.
5. The method of Embodiment 2, wherein determining that the NFp is located in the second PLMN comprises performing a network repository function, NRF, discovery operation.
6. The method of Embodiment 5, wherein a NRF response in the NRF discovery operation indicates that the NFp is located in the second PLMN.
7. The method of Embodiment 5, wherein a NRF response in the NRF discovery operation includes a fully qualified domain name for the NFp, and wherein determining that the NFp is located in the second PLMN comprises checking the fully qualified domain name to determine that the NFp is located in the second PLMN.
8. The method of any previous Embodiment, wherein delegating selection of the NFp to the second NF in the second PLMN comprises transmitting the service operation request to the second NF in the second PLMN together with service based interface, SBI, discovery parameters.
9. The method of Embodiment 8, wherein transmitting the service operation request to the second NF in the second PLMN comprises transmitting the service operation request via a security edge protection proxy, SEPP.
10. The method of Embodiment 9, wherein the SBI discovery parameters are passed transparently by the SEPP to the second NF in the second PLMN.
11. The method of any of previous Embodiment, wherein the second NF comprises an SCP.
12. The method of any previous Embodiment, further comprising:
performing initial selection of the NFp after performing the NF discovery procedure.
13. The method of any previous Embodiment, further comprising:
determining whether initial selection of the NFp should be delegated to the second network function in the second PLMN.
14. The method of Embodiment 13, wherein determining whether initial selection should be delegated to the second network function in the second PLMN comprises checking a profile of the NFp.
15. The method of Embodiment 1, wherein delegating selection of the NFp to the second NF in the second PLMN comprises transmitting the service operation request to a security edge protection proxy, SEPP, in the second PLMN.
16. The method of Embodiment 15, wherein transmitting the service operation request to the SEPP in the second PLMN comprises transmitting the service operation request to the SEPP together with service based interface, SBI, discovery parameters associated with the request.
17. The method of Embodiment 15, wherein transmitting the service operation request to the SEPP in the second PLMN comprises transmitting the service operation request to the SEPP together with a header sbi-target-apiroot set to an application programming interface root, apiroot, of the SEPP in the second PLMN.
18. The method of Embodiment 15, wherein transmitting the service operation request to the SEPP in the second PLMN comprises transmitting the service operation request to the SEPP together with a header sbi-target-apiroot set to a dummy application programming interface root, apiroot.
19. The method of Embodiment 18, wherein the dummy apiroot comprises an apiroot of the SEPP in the second PLMN.
20. The method of Embodiment 1, wherein the first NF assumes that selection of the NFp should be delegated in response to determining that the NFp is located in the second PLMN.

### Group B Embodiments

21. A method performed by a first network function, NF, in a core network, CN, of a first public land mobile network, PLMN, the method comprising:
receiving (1002) a service operation request from a NF consumer, NFc, in the first PLMN;
performing (1004) an NF discovery procedure to identify a NF producer, NFp, to which the service operation request can be transmitted;
determining (1006) that the NFp is located in a second PLMN;
determining (1008) that the service operation request should be sent to a second network function in the first PLMN;
in response to determining that the service operation request should be sent to the second network function in the first PLMN:
   transmitting (1010) the service operation request to the second network function; and
   transmitting (1012) an indication to the second network function that the NFp is located in a second PLMN.
22. The method of Embodiment 21, wherein the first network function comprises a service communication proxy, SCP, in the CN.
23. The method of Embodiment 21, wherein determining that the NFp is located in the second PLMN comprises obtaining SCP domain route information for the NFp.
24. The method of Embodiment 23, wherein obtaining the SCP domain route information for the NFp comprises obtaining the SCP domain route information for the NFp from a network repository function, NRF, in the second PLMN.
25. The method of Embodiment 22, wherein determining that the NFp is located in the second PLMN comprises performing a network repository function, NRF, discovery operation.
26. The method of Embodiment 25, wherein a NRF response in the NRF discovery operation indicates that the NFp is located in the second PLMN.
27. The method of Embodiment 25, wherein a NRF response in the NRF discovery operation includes a fully qualified domain name for the NFp, and wherein determining that the NFp is located in the second PLMN comprises checking the fully qualified domain name to determine that the NFp is located in the second PLMN.
28. The method of any of Embodiments 21 to 27, wherein the second NF comprises a service communication proxy, SCP, in the CN.
29. The method of any of Embodiments 21 to 28, wherein the indication to the second network function that the NFp is located in a second PLMN comprises a flag in the service operation request.
30. The method of Embodiment 21, wherein transmitting the service operation request to the second NF comprises transmitting the service operation request to the second NF together with service based interface, SBI, discovery parameters associated with the request.
31. A core network node (800), comprising:
a processor (803); and
a memory (805) coupled to the processor;
wherein the memory comprises computer program instructions that, when executed by the processor, cause the core network node to perform operations according to any of Embodiments 1 to 30.
32. A computer program comprising program code to be executed by processing circuitry (803) of a core network, CN, node, whereby execution of the program code causes the CN node to perform operations according to any of Embodiments 1 to 30.
   33. A computer program product comprising a non-transitory storage medium including program code to be executed by processing circuitry (803) of a core network, CN, node (800), whereby execution of the program code causes the CN node (800) to perform operations according to any of Embodiments 1 to 30.

The embodiments described with respect to FIGS. 6a to 11 and listed above may be performed in conjunction with the embodiments of FIGS. 2a to 5b, respectively with the embodiments defined in the appended claims, or independent thereof.

Although various embodiments have been described in the context of selection of NFp, these embodiments may also be used to perform reselection of NFp, such as when the NFc, pSEPP or SCP operates to perform reselection. Accordingly, the steps and related operations disclosed herein for FIGS. 1 to 5 may be used to perform reselection. Therefore, the terms “selection” and “reselection” are used interchangeably herein.

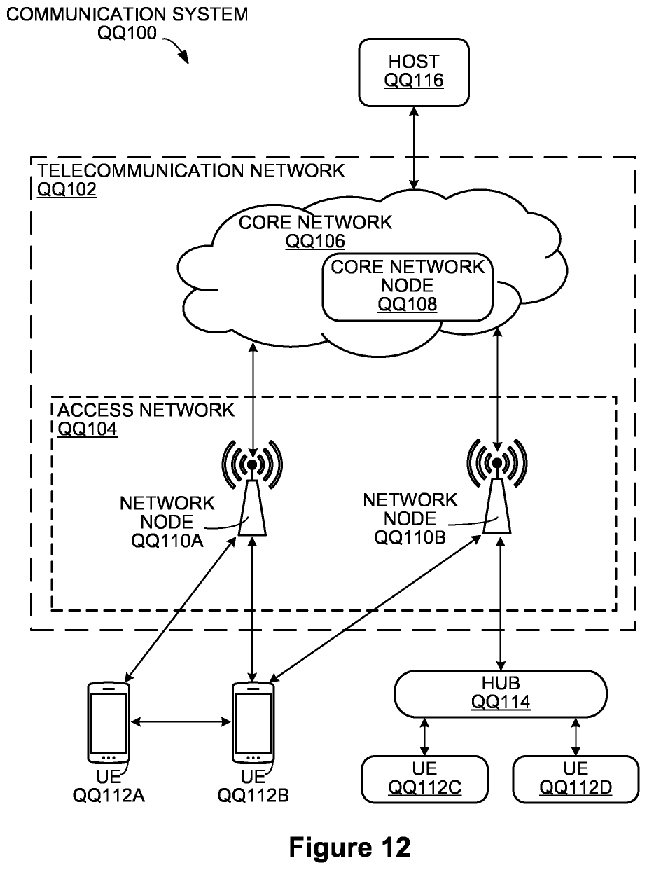

FIG. 12 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The one or more core network nodes QQ108 can correspond to the nodes illustrated in FIGS. 2a, 2b, 3, 4a, 4b, 5a, and 5c, such as the NFc, the cNRF, the cSEPP, the pSEPP, the NRF, the NFp, the SCP, etc. Processing circuitry of each of the one or more core network nodes QQ108 can be adapted to perform the corresponding operations illustrated in FIGS. 2a, 2b, 3, 4a, 4b, 5a, and 5c, in accordance with some embodiments of the present disclosure.

The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

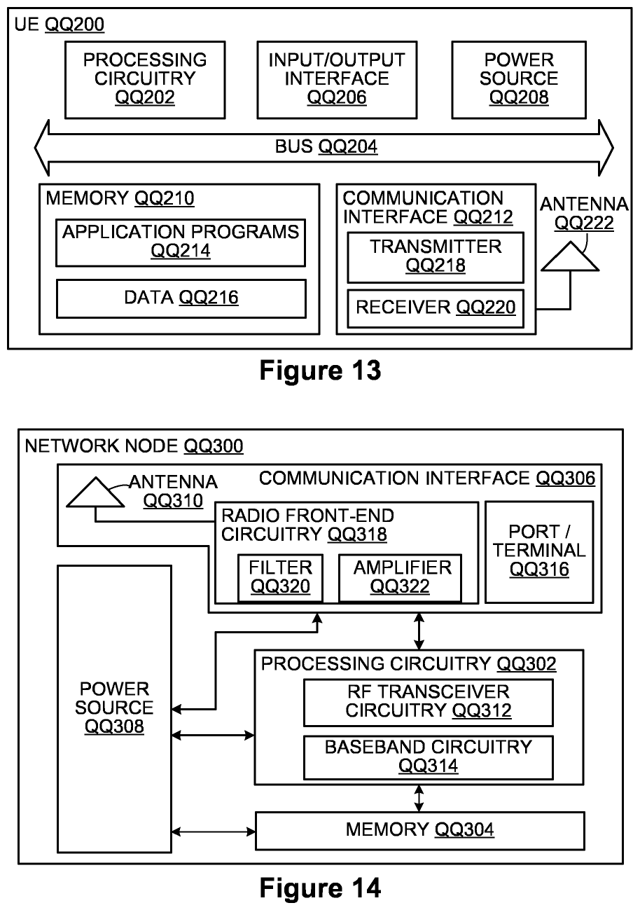

FIG. 13 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in Figure QQ2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in Figure QQ3 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

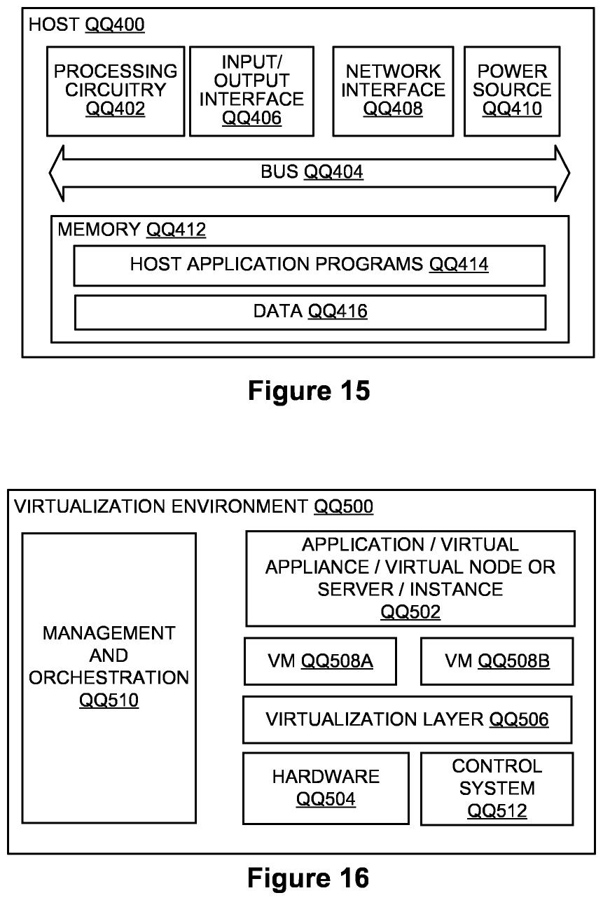

FIG. 15 is a block diagram of a host QQ400, which may be an embodiment of the host QQ116 of Figure QQ1, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

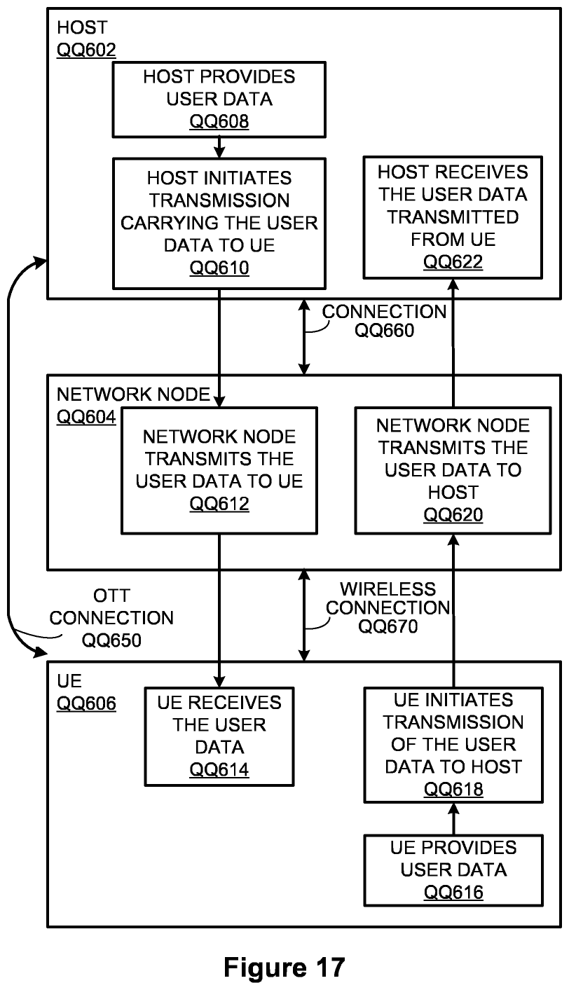

FIG. 17 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 12 and/or UE QQ200 of FIG. 13), network node (such as network node QQ110a of FIG. 12 and/or network node QQ300 of FIG. 14), and host (such as host QQ116 of FIG. 12 and/or host QQ400 of FIG. 15) discussed in the preceding paragraphs will now be described with reference to FIG. 17.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of Figure QQ1) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Abbreviations used herein are explained below:

### Abbreviation Explanation

5GC 5th Generation Core Network
AMF Access & Mobility Management Function
API Application Programming Interface
CN Core Network
CNA Cloud Native Architecture
DNN Data Network Name
NE Network Element
NF Network Function
NFc Network Function Service Consumer
NFp Network Function Service Producer
NRF Network Repository Function
PLMN Public Land Mobile Network
cPLMN Consumer PLMN
vPLMN Visited Public Land Mobile Network
hPLMN Home Public Land Mobile Network
pPLMN Producer Public Land Mobile Network
SBA Service based Architecture
SBI Service Based Interface
SCP Service Communication Proxy
SEPP Security Edge Protection Proxy
CSEPP Consumer Security Edge Protection Proxy
pSEPP Producer Security Edge Protection Proxy
UDM Unified Data Management

1.-15. (canceled)

16. A method by a service communication proxy, SCP, the method comprising:
receiving from a producer security edge protection proxy, pSEPP, a request by a network function service consumer, NFc, for a service operation, wherein the request includes information to be used to perform selection or reselection of a network function service producer, NFp, to provide the defined service operation;
identifying based on the information in the request that a new selection or reselection of NFp to provide the defined service operation is needed; and
selecting or reselecting an NFp using the information from the request.

17. The method of claim 16, further comprising:
sending a request to a network repository function, NRF, using the information from the request;
receiving a response from the NRF providing profiles for NFp instances;
selecting or reselecting among the profiles for the NFp instances to identify the NFp that satisfies a criteria for being local to the pSEPP; and
generating a service operation request for the NFp.

18. The method of claim 16, wherein the response received from the NRF provides profiles for the NFp instances that are in a same set as a set indicated by the information.

19. The method of claim 16, wherein the sending of the request to the NRF using information from the request comprises:
based on the request received from the pSEPP including a set identifier, sending a discovery request that includes the set identifier.

20. The method of claim 16, wherein the sending of the request to the NRF using information from the request, comprises:
based on the request received from the pSEPP including a NFinstanceId, getting a NFinstanceId profile for the NFinstanceId, and
sending a discovery request that includes a SetId determined based on the NFinstanceId profile.

21.-33. (canceled)

34. A method performed by a first network function, NF, in a core network, CN, of a first public land mobile network, PLMN, the method comprising:
receiving a service operation request from a NF service consumer, NFc, in the first PLMN;
performing an NF discovery procedure to identify a NF service producer, NFp, to which the service operation request can be transmitted;
determining that the NFp is located in a second PLMN; and
in response to determining that the NFp is located in the second PLMN, delegating selection of the NFp to a second NF in the second PLMN.

35. The method of claim 34, wherein the first network function comprises a service communication proxy, SCP, in the CN.

36. The method of claim 35, wherein determining that the NFp is located in the second PLMN comprises obtaining SCP domain route information for the NFp, comprising obtaining the SCP domain route information for the NFp from a network repository function, NRF, in the second PLMN.

37. The method of claim 35, wherein determining that the NFp is located in the second PLMN comprises performing a network repository function, NRF, discovery operation, wherein a NRF response in the NRF discovery operation indicates that the NFp is located in the second PLMN.

38. The method of claim 34, wherein delegating selection of the NFp to the second NF in the second PLMN comprises transmitting the service operation request to the second NF in the second PLMN together with service based interface, SBI, discovery parameters.

39. The method of claim 38, wherein transmitting the service operation request to the second NF in the second PLMN comprises transmitting the service operation request via a security edge protection proxy, SEPP.

40. The method of claim 34, further comprising:
performing initial selection of the NFp after performing the NF discovery procedure.

41. The method of claim 34, further comprising:
determining whether initial selection of the NFp should be delegated to the second network function in the second PLMN.

42. The method of claim 34, wherein delegating selection of the NFp to the second NF in the second PLMN comprises transmitting the service operation request to a security edge protection proxy, SEPP, in the second PLMN.

43. The method of claim 42, wherein transmitting the service operation request to the SEPP in the second PLMN comprises transmitting the service operation request to the SEPP together with service based interface, SBI, discovery parameters associated with the request.

44. The method of claim 42, wherein transmitting the service operation request to the SEPP in the second PLMN comprises transmitting the service operation request to the SEPP together with a header sbi-target-apiroot set to an application programming interface root, apiroot, of the SEPP in the second PLMN.

45. The method of claim 42, wherein transmitting the service operation request to the SEPP in the second PLMN comprises transmitting the service operation request to the SEPP together with a header sbi-target-apiroot set to a dummy application programming interface root, apiroot,.

46. A method performed by a first network function, NF, in a core network, CN, of a first public land mobile network, PLMN, the method comprising:
receiving a service operation request from a NF consumer, NFc, in the first PLMN;
performing an NF discovery procedure to identify a NF producer, NFp, to which the service operation request can be transmitted;
determining that the NFp is located in a second PLMN;
determining that the service operation request should be sent to a second network function in the first PLMN;
in response to determining that the service operation request should be sent to the second network function in the first PLMN:
transmitting the service operation request to the second network function; and
transmitting an indication to the second network function that the NFp is located in a second PLMN.

47. The method of claim 46, wherein the first network function comprises a service communication proxy, SCP, in the CN.

48. The method of claim 46, wherein determining that the NFp is located in the second PLMN comprises obtaining SCP domain route information for the NFp.

49. The method of claim 48, wherein obtaining the SCP domain route information for the NFp comprises obtaining the SCP domain route information for the NFp from a network repository function, NRF, in the second PLMN.

50. The method of claim 46, wherein determining that the NFp is located in the second PLMN comprises performing a network repository function, NRF, discovery operation.

51. The method of claim 50, wherein a NRF response in the NRF discovery operation indicates that the NFp is located in the second PLMN.

52. The method of claim 50, wherein a NRF response in the NRF discovery operation includes a fully qualified domain name for the NFp, and wherein determining that the NFp is located in the second PLMN comprises checking the fully qualified domain name to determine that the NFp is located in the second PLMN.

53. The method of claim 46, wherein the second NF comprises a service communication proxy, SCP, in the CN.

54. The method of claim 46, wherein the indication to the second network function that the NFp is located in a second PLMN comprises a flag in the service operation request.

55. The method of claim 46, wherein transmitting the service operation request to the second NF comprises transmitting the service operation request to the second NF together with service based interface, SBI, discovery parameters associated with the request.
